(19) United States
(12) Patent Application Publication
(10) Pub. No.: US 2025/0336659 A1
(43) Pub. Date: Oct. 30, 2025

(54) Sample Plate Holder for Mass Spectrometer

(71) Applicant: SHIMADZU CORPORATION, Kyoto-shi (JP)

(72) Inventors: Takahiro HARADA, Kyoto-shi (JP); Kenta TERASHIMA, Kyoto-shi (JP); Tomoya KUDO, Kyoto-shi (JP)

(21) Appl. No.: 18/880,404

(22) PCT Filed: Apr. 27, 2023
(86) PCT No.: PCT/JP2023/016677

§ 371 Date: Dec. 31, 2024

(30) Foreign Application Priority Data
Jul. 29, 2022 (JP) 2022-121938

(51) Int. Cl. H01J 49/04; H01J 49/16

(52) U.S. Cl. CPC H01J 49/0418; H01J 49/164

(57) ABSTRACT

A sample plate holder (6) for a mass spectrometer includes biasing members (631 to 633) configured to push one surface of a sample plate (5) toward the other surface, and contact members (612 to 614) configured to abut on the other surface of the sample plate at three positions not located on a straight line in plan view. The sample plate holder (6) can be suitably used in a mass spectrometer (1) including a laser light irradiation unit (13) configured to irradiate a sample(S) placed on the sample plate with laser light and a mass spectrometry unit (30) configured to perform mass spectrometry of ions generated from the sample by irradiation with the laser light.

### TECHNICAL FIELD

The present invention relates to a sample plate holder that holds a sample plate used in a mass spectrometer that irradiates a sample with laser light and performs mass spectrometry of ions generated from the sample.

### BACKGROUND ART

In order to observe a distribution of a target substance in a sample, imaging mass spectrometry using a mass spectrometer equipped with MALDI is performed (for example, Patent Literature 1). MALDI is an ion source that ionizes the sample by a matrix-assisted laser desorption/ionization method.

In an imaging mass spectrometry using MALDI, a matrix substance is applied to a surface of a sample placed on a sample plate, where the matrix substance is an easily ionized substance, so that microcrystals of the matrix substance incorporating molecules of the sample are formed. When the sample plate on which thus pretreated sample is placed is set at a predetermined position of MALDI and the sample surface is irradiated with laser light, the microcrystals of the matrix substance are heated, and the sample molecules are desorbed and ionized. Ions generated from the sample molecules are taken into a mass spectrometry unit, separated according to mass-to-charge ratio by an appropriate method, such as measuring the difference in speed after acceleration by an electric field, and detected. Then a mass spectrum representing mass-to-charge ratio on the horizontal axis and signal intensity on the vertical axis is obtained. By performing such ionization and mass spectrometry steps at each of a plurality of measurement points two-dimensionally located on the sample surface, a mass spectrum of each measurement point is obtained. By showing (mapping) the intensity of a mass peak corresponding to the target substance on the mass spectrum acquired at each measurement point on the measurement point, an image showing the distribution of the target substance on the sample surface is obtained.

In an imaging mass spectrometry, laser light condensed by a condensing optical system such as a lens or a concave mirror is used in order to irradiate each measurement point with the laser light having an energy density at which ionization efficiency of the sample is maximized. Therefore, when the height of the sample plate deviates from a predetermined position, the energy density of the laser light with which the sample surface is irradiated decreases, and the ionization efficiency deteriorates, resulting in the decrease in the measurement sensitivity. In addition, the diameter of the irradiation spot on the sample surface increases, and the spatial resolution of the mass distribution image decreases. Therefore, in MALDI, it is critical to fix the sample plate at a predetermined position and height.

A sample plate holder is used to secure the sample plate to the predetermined position and height of the MALDI. There are various forms of sample plate holders. Non Patent Literature 1 describes a sample plate holder in which a rectangular sample plate is pushed upward by extrusion pins positioned at the center of both short sides of the sample plate, while both short ends of the upper surface of the sample plate abut on stop surfaces provided on the sample plate holder to fix the sample plate. Non Patent Literature 2 describes a sample plate holder in which an extension portion provided so as to extend outward along both long sides of a rectangular sample plate is inserted into an insertion slot provided in MALDI, and the center of a lower surface of the sample plate is pushed upward by a presser spring to fix the sample plate. Non Patent Literature 3 describes a sample plate holder in which a central portion of a lower surface of both short sides of a rectangular sample plate is pushed upward by a presser spring, and an upper surface of the sample plate is brought into contact with a projecting side provided above the presser spring to hold the sample plate.

### CITATION LIST

### Patent Literature

Patent Literature 1: JP 2021-196303 A

### Non Patent Literature

Non Patent Literature 1: “rapifleX (registered trademark) MALDI Tissuetyper (registered trademark)”, [online], Bruker Corporation, [searched on Jul. 6, 2022], Internet <URL: https://www.bruker.com/ja/products-and-solutions/mass-spectrometry/maldi-tof/rapiflex-maldi-tissuetyper.html>
Non Patent Literature 2: “Benchtop Linear MALDI-TOF Mass Spectrometer MALDI-8020”, [online], Shimadzu Corporation, [searched on Jul. 6, 2022], Internet <URL: https://www.an.shimadzu.co.jp/ms/maldi8020/index.htm>
Non Patent Literature 3: “Imaging Mass Microscope iMScope QT”, [online], Shimadzu Corporation, [searched on Jul. 6, 2022], Internet <URL: https://www.an.shimadzu.co.jp/bio/imscope_qt/index.htm>

### SUMMARY OF INVENTION

### Technical Problem

In the sample plate holders of Non Patent Literatures 1 and 2, the point (position) at which the sample plate is pushed up from below by the extrusion pin or the presser spring and the points (positions) at which the upper surface of the sample plate are stopped by the sample plate holder are different in plan view. In these sample plate holders, the sample plate is bent because the positions where the forces are applied to the sample plate are different below and above. When, for example, a glass sample plate with a surface conductive film having a thickness of about 1 mm is used, the sample plate bends by tens of ums due to such a force.

In imaging mass spectrometry, in many cases, the laser light is irradiated on the surface of the sample plate in an oblique direction. When the sample plate is bent, the irradiated position deviates from the intended point. When the measurement points deviate, the image of the distribution of the target substance on the sample surface does not show a correct distribution of the target substance. When the sample plate is bent, further, the surface height of the sample placed on it also deviates, and the measurement sensitivity decreases or the spatial resolution deteriorates as described above.

In a vacuum MALDI-TOF, in which both MALDI and TOF are accommodated in a vacuum chamber, ions generated by MALDI are directly introduced into a flight space, so that the deviation in the height of the sample surface directly influences a deviation in the flight distance, and as a result, mass accuracy in mass spectrometry decreases. In a mass spectrometer including atmospheric pressure MALDI, in order to maintain high vacuum in the vacuum chamber provided with a mass spectrometry unit, the diameter of an ion intake port is set to a minimum size (for example, about several mm), and when the measurement points deviate, the amount of ions taken into the ion intake port decreases, and the measurement sensitivity decreases.

In the sample plate holder of Non Patent Literature 3, when there is slight distortion on a lower surface of a projecting piece due to manufacturing error of the sample plate holder, or when the lower surfaces of two projecting pieces are not parallel, the upper surface of the sample plate and the lower surfaces of the projecting pieces contact each other not on a plane but at points. Since the point at which the sample plate is pushed up from below by the presser spring and the points at which the upper surface of the sample plate abut on the lower surface of the projecting piece are at different positions in plan view, distortion occurs in the sample plate similarly to the sample plates of Non Patent Literatures 1 and 2, and as a result, the same problem as described above occurs.

An object of the present invention is to provide a sample plate holder for a mass spectrometer that can be held without causing distortion in the sample plate.

### Solution to Problem

According to the present invention made to solve the above problems, a sample plate holder for a mass spectrometer includes:
a biasing member configured to press one surface of a sample plate at three positions not located on a straight line; and
a contact member which abuts on another surface of the sample plate at positions corresponding to the three positions in plan view.

### Advantageous Effects of Invention

In the sample plate holder according to the present invention, the biasing member presses one surface (for example, a lower surface) of the sample plate at three positions (three points) not located on a straight line, and the biasing member is brought into contact with the contact member at positions corresponding to the three points in plan view. In the sample plate holder according to the present invention, since the force points that press the sample plate and the support points that abut on and support the sample plate are at positions corresponding to each other in plan view, distortion does not occur in the sample plate. Since a flat plane is defined by three points not positioned on a straight line, the sample plate can be held such that the surface of the sample plate is always held at the same position and height by using the sample plate holder according to the present invention.

### BRIEF DESCRIPTION OF DRAWINGS

FIG. 1 A configuration diagram of a main part of a mass spectrometer in which a sample plate holder according to the present invention is used.

FIG. 2 An external view of the sample plate holder according to a first embodiment.

FIG. 3 A view for explaining a configuration of an upper frame member of the sample plate holder according to the first embodiment.

FIG. 4 A cross-sectional view of the sample plate holder according to the first embodiment.

FIG. 5 A view for explaining a configuration of an upper frame member of a sample plate holder according to a modification of the first embodiment.

FIG. 6 A view for explaining a shape of a presser spring of a sample plate holder according to a second embodiment.

FIG. 7 An enlarged view of a contact portion between the sample plate holder and a sample plate according to the second embodiment.

FIG. 8 A view for explaining a state in which warpage occurs in the sample plate.

FIG. 9 A view for explaining a configuration of a sample plate holder according to a third embodiment.

FIG. 10 An enlarged view of a contact portion between the sample plate holder and a sample plate according to the third embodiment.

FIG. 11 A view for explaining that the sample plate is held by the sample plate holder according to the third embodiment without causing warpage in the sample plate.

FIG. 12 A view for explaining a tapered portion of a projecting portion in the sample plate holder according to the third embodiment.

FIG. 13 A view for describing a modification of the third embodiment in which a presser spring is inclined and fixed.

### DESCRIPTION OF EMBODIMENTS

Hereinafter, embodiments of a sample plate holder for a mass spectrometer according to the present invention will be described with reference to the drawings.

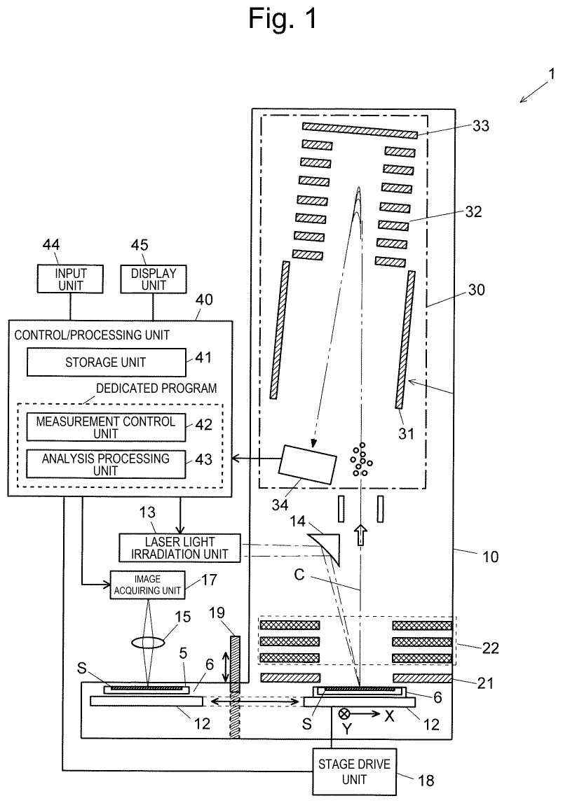

FIG. 1 is a configuration diagram of a main part of a mass spectrometer in which a sample plate holder according to each embodiment described below is used. This mass spectrometer 1 is a MALDI-TOF MS. That is, the mass spectrometer 1 has an ion source (vacuum MALDI in the present embodiment) that ionizes a sample by a matrix-assisted laser desorption/ionization method, and a time-of-flight mass spectrometry unit that causes ions generated by the ion source to fly and separates and detects the ions according to a mass-to-charge ratio.

The mass spectrometer 1 of the present embodiment includes a stage 12 on which a sample plate holder 6 holding a sample plate 5 on which a sample S is placed is set, a laser light irradiation unit 13 that emits laser light, a concave reflecting mirror 14 that condenses the laser light emitted from the laser light irradiation unit 13 on the sample S, and an image acquiring unit 17 that images the sample S. There is provided a stage drive unit 18 including a motor or the like that moves the stage 12 between an imaging position (left side in FIG. 1) and a measurement position (right side in FIG. 1) of the sample S and moves the stage in a horizontal direction (biaxial directions of an X axis and a Y axis in FIG. 1) at the measurement position.

Immediately above the measurement position of the stage 12 are provided an acceleration electrode 21 that extracts and accelerates upward the ions generated from the sample S placed on the sample plate holder 6, and an ion lens 22 as an ion transport optical system that transports the ions accelerated by the acceleration electrode 21 to a mass spectrometry unit 30 described later.

The mass spectrometry unit 30 has a reflectron-type configuration including a flight tube 31 that is a cylindrical electrode that defines a free flight space in which ions freely fly without being affected by an electric field, a reflectron 32 that is a ring-shaped electrode that turns back and flies ions by an action of a DC electric field, and a back plate 33 that is a disk-shaped electrode. An ion detector 34 is disposed at the end of a flight path of ions defined by these electrodes. A detection signal by the ion detector 34 is converted into digital data by an analog-to-digital converter (not illustrated) and input to a control/processing unit 40.

Each of the above units is accommodated in a chamber 10. The inside of the chamber is partitioned by a gate valve 19 at a lower position indicated by a broken line in FIG. 1 into an atmospheric pressure space including the imaging position of the sample S and a vacuum space including the measurement position and the mass spectrometry unit 30. When the stage 12 is moved between the imaging position and the measurement position, the gate valve 19 is released (moved to an upper position indicated by a solid line in FIG. 1). The vacuum space is evacuated by a vacuum pump (not illustrated). Here, the inside of the chamber 10 is partitioned into the atmospheric pressure space and the vacuum space in order to facilitate description. In addition to the atmospheric pressure space in which the sample S is imaged and a high vacuum space in which ions are mass-analyzed, one or a plurality of spaces having an intermediate degree of vacuum may be appropriately provided between the atmospheric pressure space and the vacuum space.

The control/processing unit 40 includes a storage unit 41. The storage unit 41 stores a compound database storing information such as measurement conditions and analysis parameters of various compounds, information (mass conversion information) for converting a time-of-flight of an ion into a mass-to-charge ratio of the ion, and the like. The control/processing unit 40 further includes functional blocks such as a measurement control unit 42 that controls the operation of each of the above-described units and executes measurement, and an analysis processing unit 43 that analyzes data obtained by measurement. The control/processing unit 40 is made of, for example, a general computer, and these functional blocks are embodied by executing with a processor dedicated software installed in advance. An input unit 44 for a user to input appropriate information and a display unit 45 for displaying various types of information are connected to the control/processing unit 40.

Next, a flow of imaging mass spectrometry of the sample in the mass spectrometer 1 of the present embodiment will be described. Measurement of a sample for imaging mass spectrometry is executed by control of each unit by the measurement control unit 42 (application of a voltage from a power supply (not illustrated) to each electrode, or the like), and analysis of data acquired by the measurement is executed by the analysis processing unit 43.

First, the user places the sample S to be analyzed on the sample plate 5, and applies a matrix substance, which is an easily ionized substance, to the surface of the sample S. As a result, microcrystals of the matrix substance incorporating molecules of the sample S are formed on the surface of the sample S.

Next, the sample plate 5 on which the processed sample S is placed is held by the sample plate holder 6 and set on the stage 12. Then, the stage 12 is disposed at the imaging position of the sample S, and the surface of the sample S on the sample plate holder 6 is imaged. The image acquired by the image acquiring unit 17 is displayed on a screen of the display unit 45. The user checks this screen, sets a region of interest (ROI) where imaging mass spectrometry is performed, and sets a plurality of measurement points two-dimensionally (for example, in a lattice pattern) in the region of interest.

After setting the plurality of measurement points in the region of interest, when the user instructs to start measurement, the gate valve 19 is released, and the stage drive unit 18 moves the stage 12 from the imaging position of the sample S to the measurement position. When the stage moves to the measurement position, a predetermined voltage (including in a case of grounding) is applied to the sample plate 5 and the sample plate holder 6. As a result, a potential gradient is formed between the sample plate 5 and the sample plate holder 6, and the acceleration electrode 21. Thereafter, the stage drive unit 18 moves the stage 12 so that a first measurement point is located at an irradiation position of the laser light. Then, the laser light is emitted from the laser light irradiation unit 13, and the laser light reflected and condensed by the concave reflecting mirror 14 and condensed at the first measurement point is emitted.

By irradiation with the condensed laser light, the microcrystals of the matrix substance are heated at the measurement point of the sample S, and the sample molecules are desorbed and ionized. Ions generated from the measurement point of the sample S are extracted upward and accelerated by the potential gradient between the sample plate 5 and the acceleration electrode 21.

The ions extracted above the sample S are transported to the mass spectrometry unit while being converged along a central axis (ion optical axis C) in a flight direction by the ion lens 22. The ions that have entered the mass spectrometry unit 30 travel straight in the free flight space surrounded by the flight tube 31, and then turn back in the space surrounded by the reflectron 32 to be incident on the ion detector 34. The ion detector 34 sequentially outputs a signal corresponding to the amount of the incident ions. The signal output from the ion detector 34 is digitally converted and sent to the control/processing unit 40.

When a series of measurements from laser light irradiation to ion detection is completed at the first measurement point, the stage drive unit 18 moves the stage 12 so that the next measurement point is located at the laser light irradiation position. Then, the laser light is emitted from the laser light irradiation unit 13, and the laser light reflected and condensed by the concave reflecting mirror 14 and condensed at a second measurement point is emitted. Thereafter, mass spectrum data of the second measurement point is obtained by the same processing as described above. When the series of measurements is completed for all the measurement points, the measurement operation is terminated.

The control/processing unit 40 converts the time-of-flight of the ion into the mass-to-charge ratio of the ion based on the mass conversion information stored in the storage unit 41, and generates mass spectrum data in which the mass-to-charge ratio of the ion is associated with a measurement intensity. The generated mass spectrum data is stored in the storage unit 41 in association with position information of the measurement points.

After the mass spectrum data of each measurement point is created and stored, for example, when the user makes an input to specify the mass-to-charge ratio of the ions specific to the target substance, the analysis processing unit 43 extracts information on the measurement intensity of the ions of the mass-to-charge ratio from the mass spectrum data obtained for each measurement point. Then, image data in which the measurement intensity of the ion is displayed in a discriminated manner at the position of each measurement point (for example, a color or brightness corresponding to the measurement intensity is added) is generated, and the image is displayed on the screen of the display unit 45. The user can know the distribution of the target substance in the sample S by checking the image displayed on the screen of the display unit 45.

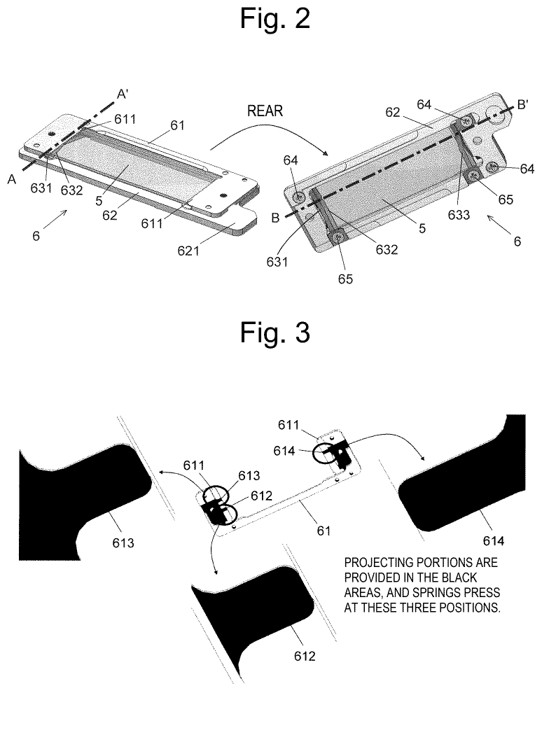

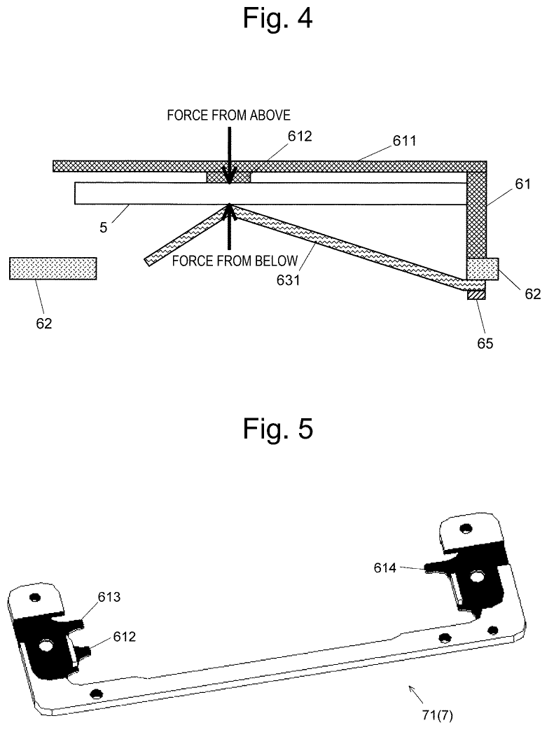

Next, the sample plate holder 6 of the first embodiment will be described with reference to FIGS. 2 to 4. FIG. 2 is an external view (left is a view from above and right is a view from below) of the sample plate holder 6 holding the sample plate 5, FIG. 3 is a view of an upper frame member 61 as viewed from a lower side, and FIG. 4 is an A-A′ cross-sectional view of the sample plate holder 6. In the drawings used in the following description, in order to facilitate understanding of the relationship and shape of each member, each member is appropriately illustrated on a scale different from the actual size, or the shape is exaggerated. Note that “above and below” and the like in the present specification are described for convenience of description, and do not limit an orientation when using the sample plate holder.

The sample plate holder 6 is roughly made of an upper frame member 61 and a lower frame member 62, which are fixed by screws 64 and 65.

The upper frame member 61 is a frame member having a substantially rectangular shape as a whole and having a shape opened from the center to one long side, and a projecting piece 611 (corresponding to a reinforcing member described later) having a flat upper surface and projecting inward is formed at upper ends on both short sides. The central opening has a size corresponding to a region where the sample S is placed on the sample plate 5.

Two contact surfaces are provided on a back surface of the projecting piece 611 on one short side (first short side) of the upper frame member 61. The contact surface is a portion that abuts on an upper surface of the sample plate 5 in a state where the sample plate is held, and is formed by projecting portions 612 and 613 (corresponding to a contact member in the present invention) projecting toward the back surface side from other portions of the projecting piece 611 (see FIG. 3). One contact surface is provided on the back surface of the projecting piece 611 on the other short side (second short side) of the upper frame member 61. This contact surface is also a portion that abuts on the upper surface of the sample plate 5 in a state where the sample plate 5 is held, and is formed by a projecting portion 614 (corresponding to the contact member in the present invention) that projects to the back surface side of the other portion of the projecting piece 611.

The lower frame member 62 is a member having a substantially rectangular outer shape slightly larger than the upper frame member 61 and having an opening at the center, and a grip portion 621 is provided on one short side for gripping the sample plate holder 6 when transporting the sample plate holder 6 and the like.

Presser springs 631 and 632 (corresponding to a biasing member in the present invention) that bias the sample plate 5 upward at positions below the two projecting portions 612 and 613 in plan view are attached to one short side (first short side) of the lower frame member 62. A presser spring 633 (corresponding to the biasing member in the present invention) that biases the sample plate 5 upward at a position below the projecting portion 614 in plan view is attached to the other short side (second short side) of the lower frame member 62. Each of the presser springs 631, 632, and 633 of the present embodiment is a leaf spring having a bent cross section (see FIG. 4), and one end of the presser spring is fixed to a lower surface of the lower frame member 62 with a screw 65 such that the bent portion faces the upper frame member 61 side.

When the sample plate 5 is held by the sample plate holder 6, the sample plate 5 is inserted between the upper frame member 61 and the lower frame member 62 from the side where the long side portion of the upper frame member 61 is opened. The inserted sample plate 5 is pushed up toward the upper frame member 61 side at three positions (three points) by the presser springs 631, 632, and 633. The upper surface of the sample plate 5 pushed up toward the upper frame member 61 side is held in contact with the projecting portions 612, 613, and 614 at three positions (three points).

When imaging mass spectrometry is performed as in the present embodiment, the laser light is condensed and emitted in order to irradiate each measurement point with the laser light having an energy density that maximizes the amount of ions generated from each measurement point of the sample S (maximizes ionization efficiency). Therefore, when the height of the sample plate 5 deviates from a predetermined position, the energy density of the laser light with which the surface of the sample S is irradiated decreases, ionization efficiency deteriorates, and measurement sensitivity decreases. An irradiation spot diameter of the laser light with which the surface of the sample S is irradiated increases, and a spatial resolution of the mass distribution image decreases. Therefore, in MALDI, it is necessary to fix the sample plate at a predetermined position and height.

However, in a conventionally used sample plate holder, since a position where a force is applied from above to the sample plate is different from a position where a force is applied from below, the sample plate may be held in a distorted state. As the sample plate, for example, one obtained by applying a conductive film on a surface of glass is used. The sample plate 5 has a thickness of about 1 mm, but in the conventional sample plate holder, such a force may cause distortion of about several tens of ums in height.

In particular, in the MALDI configured to irradiate the surface of the sample plate 5 with the laser light from the oblique direction as in the present embodiment, when the sample plate 5 is distorted, the laser light is emitted to a position deviated from the original measurement point. When the measurement points deviate, even if an image showing the distribution of the target substance on the surface of the sample S is created from the mass spectrometry data obtained at each measurement point, an image showing a correct distribution of the target substance cannot be obtained. When distortion occurs in the height direction of the sample plate 5, the height of the sample S placed on the surface of the sample plate 5 also deviates, and the measurement sensitivity decreases or the spatial resolution deteriorates as described above.

In the vacuum MALDI-TOF as in the present embodiment, since the ions generated by MALDI are directly introduced into the flight space, the deviation in the height of the surface of the sample S directly leads to a deviation in the flight distance. As a result, mass accuracy in mass spectrometry decreases. This problem similarly occurs in mass spectrometry without imaging (for example, mass spectrometry performed by placing a sample in which a matrix substance is mixed on each of a plurality of wells provided in a sample plate).

The present embodiment is a mass spectrometer including vacuum MALDI, but in a mass spectrometer including atmospheric pressure MALDI, in order to maintain high vacuum in a vacuum chamber, a diameter of an aperture that partitions the atmospheric pressure space where the sample is irradiated with the laser light and the vacuum space where ions generated from the sample are subjected to mass spectrometry is set to a minimum size (for example, about several mm). Therefore, when the measurement points deviate, the amount of ions passing through the aperture decreases, and the measurement sensitivity decreases.

On the other hand, in the sample plate holder 6 of the first embodiment, the presser springs 631, 632, and 633 are provided at positions corresponding to the projecting portions 612, 613, and 614 respectively (positions below the projecting portions 612, 613, and 614 in plan view). When the sample plate 5 is held using the sample plate holder 6, a force is applied at the same position from above and below the sample plate 5, so that the sample plate 5 can be held by the sample plate holder 6 without causing distortion in the sample plate 5. Since a single plane is defined by three points that are not positioned on a straight line, by using the sample plate holder 6, the sample plate holder 6 can hold the sample plate 5 such that the surface of the sample plate 5 is always at the same position and height.

In the sample plate holder 6 of the first embodiment, two points along one short side of the sample plate 5 and one point along the other short side are held by the sample plate holder 6. More generally speaking, at least one contact portion (a portion where the sample plate 5 is held by the sample plate holder 6) is provided in each of two regions divided by a plane passing through the center of gravity of the sample plate 5 and perpendicular to the surface of the sample plate 5. Therefore, the sample plate 5 can be stably held as compared with a case where three contact portions are provided only in one of the two regions.

The sample plate holder 6 of the first embodiment is designed based on the technical idea of holding the sample plate 5 from above and below at three points that are not on a straight line as described above, and the sample plate holder according to this technical idea can be configured without necessarily providing the projecting piece 611.

FIG. 5 illustrates a configuration of an upper frame member 71 of a sample plate holder 7 according to a modification. Since the lower frame member of the sample plate holder 7 according to the modification has the same configuration as the lower frame member 62 of the above embodiment, a description of the configuration will be omitted.

As illustrated in FIG. 5, the upper frame member 71 is provided with only members corresponding to the projecting portions 612, 613, and 614, and without being provided with members corresponding to the projecting piece 611 in the above embodiment. Also by using the sample plate holder 7 having such a configuration, the sample plate 5 can be held without causing distortion.

However, in a case where a potential gradient is formed between the acceleration electrode 21 (in the case of vacuum MALDI) and a partition wall (in the case of atmospheric pressure MALDI) by applying a voltage to the sample plate 5 and the sample plate holder 6, when a step between the upper surface of the sample plate 5 and the upper surface of the sample plate holder 6 becomes large, a disturbance of the electric field may occur at that portion. Therefore, it is necessary to make the projecting piece 611 of the sample plate holder 6 as thin as possible. In the sample plate holder 6 of the above embodiment, the thickness of the projecting piece 611 is 0.5 mm, and the thicknesses of the projecting portions 612, 613, and 614 are 0.1 mm. That is, the step between the upper surface of the sample plate 5 and the upper surface of the sample plate holder 6 is suppressed to 0.6 mm.

In the sample plate holder 7 of the modification, when the projecting portions 612, 613, and 614 are thinned in order to reduce the step between the upper surface of the sample plate 5 and the upper surface of the sample plate holder 6 as described above, the strength of the projecting portions 612, 613, and 614 is insufficient, and there is a possibility that the projecting portions are deformed or damaged while being repeatedly used. Since there is a step in an upper surface of the upper frame member 71 of the sample plate holder 7 between a portion where the projecting portions 612, 613, and 614 are provided and a portion where the projecting portions are not provided, there is a possibility that the disturbance of the electric field also occurs. In consideration of these points, as in the sample plate holder 6 of the above embodiment, it is preferable to provide the projecting piece 611 having the flat upper surface and form the projecting portions 612, 613, and 614 integrally with the projecting piece 611.

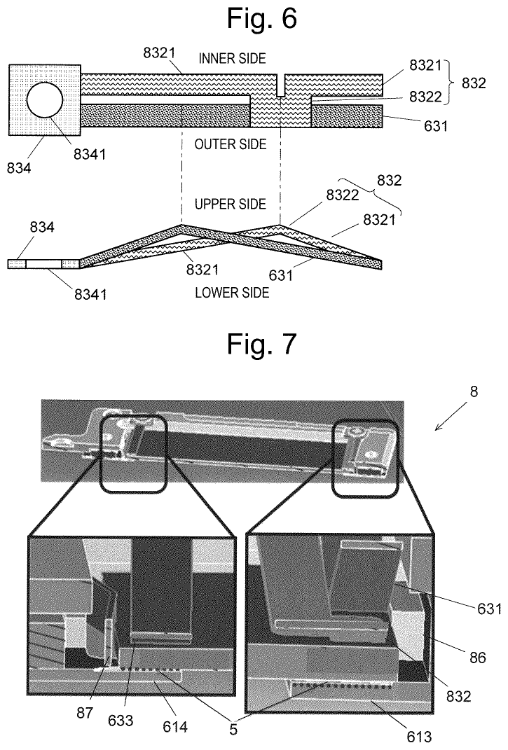

When the sample plate 5 is held using the sample plate holders 6 and 7, distortion (warpage or twisting) of the sample plate 5 can be suppressed as compared with the conventional sample plate holder. However, as a result of further study by the present inventor, the present inventor has found a configuration capable of more reliably suppressing distortion of the sample plate 5. Hereinafter, that sample plate holder 8 will be described with reference to FIGS. 6 to 12. In the following description, the same components as those of the sample plate holder 6 are denoted by the same reference numerals, and a description of the components will be omitted as appropriate.

This examination was performed by the sample plate holder 8 according to a second embodiment. The sample plate holder 8 according to the second embodiment will be described with reference to FIGS. 6 to 8. The upper part of FIG. 6 is a view illustrating the presser spring 631 and a presser spring 832 as viewed from an upper surface side of the sample plate holder 8, and the lower part of FIG. 6 is a view illustrating the presser springs 631 and 832 as viewed from the outside of a short side of the sample plate holder 8. As illustrated in these drawings in which a plate-shaped fixation section 834 for fixing the presser springs 631 and 832 is provided on a base portion side of each of the presser springs 631 and 832, and an opening 8341 for inserting the screw 65 is formed in the fixation section 834, the presser spring 631 is a linear leaf spring, while the presser spring 832 includes a linear portion 8321 and an extension portion 8322 extending from the linear portion 8321 toward the presser spring 631, and the extension portion 8322 abuts on the sample plate 5. Alternate long and short dash lines in FIG. 6 indicate positions where the presser springs 631 and 832 abut on the projecting portions 612 and 613.

FIG. 7 is an enlarged view of contact portions between the presser springs 832 and 633 of the sample plate holder 8 and the sample plate 5, and contact portions between the sample plate 5 and the projecting portions 613 and 614.

In the sample plate holder 8, a wall portion 86 (corresponding to a side member in the present invention) is erected from the projecting piece 611 toward the lower frame member 62 on the outer side of a side surface on one short side of the sample plate 5 (surface on which the presser springs 631 and 832 are located), and a leaf spring 87 that presses a side surface on the other short side of the sample plate 5 toward the wall portion 86 is disposed on the outer side of the side surface on the other short side (surface on the side where the presser spring 633 is located). In the sample plate holder 8, the projecting piece 611 and the wall portion 86 are made of one member, but the projecting piece 611 and the wall portion 86 may be made of different members. As a result, even if the length in a long side direction of the sample plate 5 is different for each manufacturer, both side surfaces of the sample plate 5 can be sandwiched between the wall portion 86 and the leaf spring 87 and stably held.

Also in the sample plate holder 8, the presser springs 631 and 832 and the presser spring 633 are each attached near both end portions of a long side of the lower frame member 62 of the sample plate holder 8 by two screws 65. At this time, a surface accuracy of a spring mounting portion of the lower frame member 62 may deteriorate due to a machining error at the time of manufacturing the sample plate holder 8. Then, the presser springs 631 and 832 and the presser spring 633 are attached in an inclined manner. When the presser springs 631, 832, and 633 are attached so as to be inclined inward and away from the sample plate 5, outer end portions of the presser springs 631, 832, and 633 abut on the sample plate 5. On the other hand, when the presser springs 631, 832, and 633 are attached to be inclined so as to approach the sample plate 5 toward the inside, inner end portions of the presser springs 631, 832, and 633 abut on the sample plate 5.

In addition, as for the projecting portions 612 to 614, contact surfaces of the projecting portions 612 to 614 (surfaces abutting on the sample plate 5) may be inclined due to a machining error at the time of manufacturing the sample plate holder 6. When the contact surfaces of the projecting portions 612 to 614 are inclined inward and away from the surface of the sample plate 5, outer end portions (base portions) of the projecting portions 612 to 614 abut on the sample plate 5. On the other hand, when the projecting portions 612 to 614 are inclined so as to approach the sample plate 5 inwardly, inner end portions (tip portions) of the projecting portions 612 to 614 abut on the sample plate 5.

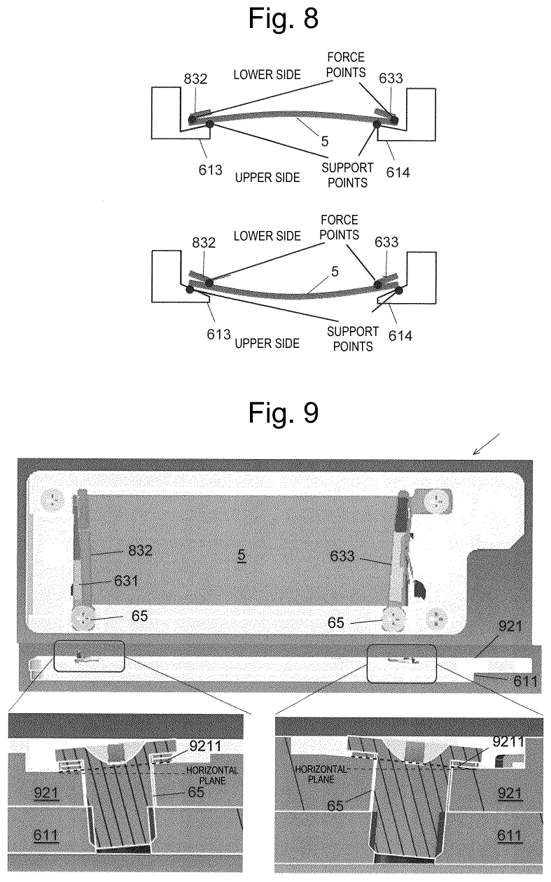

Then, a state as illustrated in FIG. 8 may occur. FIG. 8 corresponds to a B-B′ cross section in FIG. 2 of the sample plate holder 8 holding the sample plate 5. The upper and lower parts of FIG. 8 are inverted, and the lower surface of the sample plate holder 8 is positioned in the upper part of FIG. 8. In the upper part of FIG. 8, the outer end portions of the presser springs 832 and 633 abut on the sample plate 5, and the tip portions of the projecting portions 613 and 614 abut on the sample plate 5. When the sample plate 5 is held in this state, a slight deviation occurs between the positions where the presser springs 832 and 633 press the sample plate 5 and the positions where the sample plate 5 is supported by the projecting portions 613 and 614. As a result, the sample plate 5 warps downward.

In the lower part of FIG. 8, the inner end portions of the presser springs 832 and 633 abut on the sample plate 5, and the base portions of the projecting portions 613 and 614 abut on the sample plate 5. Even if the sample plate 5 is held in this state, there is a slight deviation between the positions where the presser springs 832 and 633 press the sample plate 5 and the positions where the sample plate 5 is supported by the projecting portions 613 and 614. As a result, the sample plate 5 warps upward.

As described above, in order to more reliably avoid the sample plate 5 from being warped due to a machining error at the time of manufacturing, a sample plate holder 9 of a third embodiment is further improved.

FIG. 9 illustrates a configuration of the sample plate holder 9 of the third embodiment. The upper part of FIG. 9 is a view of the sample plate holder 9 as viewed from the lower side, and the lower part of FIG. 9 is a cross-sectional view showing a structure of the spring mounting portion. In the following description, components common to the sample plate holders 6 and 8 are denoted by the same reference numerals, and detailed descriptions of the components are omitted.

In the sample plate holder 9, a spring mounting surface 9211 of a lower frame member 92 is inclined from the horizontal. More specifically, the spring mounting surface is inclined by 5 degrees from the horizontal so as to be thick toward the inside of the sample plate holder 9. A screw hole is formed perpendicular to the inclined surface. Therefore, when the presser springs 631, 832, and 633 are attached, they are also attached in a state of being inclined by 5 degrees with respect to a horizontal plane.

The presser springs 832 and 633 are also mounted in an inclined manner in the horizontal direction (direction parallel to the surface of the sample plate 5) so as to open outward with increasing distance from the screw 65. This is to avoid interference with a wall portion 96 and a leaf spring 97 to be described later. If the wall portion 96 and the leaf spring 97 are provided at positions not interfering with the presser springs 832 and 633, the presser springs 832 and 633 may not be inclined in the horizontal direction (may be disposed in parallel with the short side of the sample plate 5).

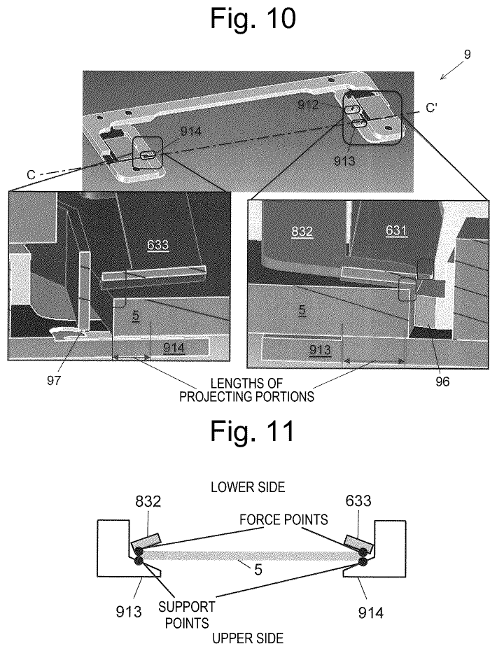

The upper part of FIG. 10 is a perspective view of the sample plate holder 9 as viewed from the lower surface side (however, the lower frame member 62, the presser springs 631, 832, and 633, and the screws 64 and 65 are not illustrated). The lower part of FIG. 10 is an enlarged cross-sectional view of the vicinity of both end portions on the short side of the sample plate 5 (a view corresponding to a C-C′ cross section in the upper part of FIG. 10). Also in the sample plate holder 9, similarly to the sample plate holder 8, the wall portion 96 (corresponding to the side member in the present invention) is erected from the projecting piece 611 toward the lower frame member 62 on the outer side of the side surface on one short side of the sample plate 5 (surface on which the presser springs 631 and 832 are located), and the leaf spring 97 that pushes the side surface on the other short side of the sample plate 5 toward the wall portion 96 is disposed on the outer side of the side surface on the other short side (surface on the side where the pressing spring 633 is located). Also in the sample plate holder 9, the projecting piece 611 and the wall portion 96 are made of one member, but these members may be made of different members. As a result, similarly to the sample plate holder 8, both side surfaces of the sample plate 5 having slightly different sizes (lengths on the long side) for each manufacturer can be sandwiched and stably held by the wall portion 96 and the leaf spring 97.

However, in the sample plate holder 9, as illustrated in the lower part of FIG. 10, the wall portion 96 is formed to be lower than the thickness of the sample plate 5, and a gap is provided between the leaf spring 97 and the sample plate 5 at the position of the C-C′ cross section in FIG. 10. That is, the position where the leaf spring 97 presses the sample plate 5 and the position where the leaf spring 633 presses the sample plate deviate from each other. By being formed in this manner, the leaf springs 631, 832, and 633 do not interfere with the wall portion 96 or the leaf spring 97, and abut on a ridgeline of the sample plate 5 (edge portion on the short side of the surface of the sample plate 5; corner portion in the C-C′ cross section). As a result, a positional relationship between the force points and the support points in the sample plate 5 precisely coincides in plan view, and the state illustrated in the lower part of FIG. 8 is avoided. As a result of variously changing angles at which the presser springs 631, 832, and 633 are inclined, if the inclination angle is less than 1 degree, the presser springs 631, 832, and 633 may not abut on the ridgeline of the sample plate 5 when a machining error of a spring mounting surface of the lower frame member 62 is large. Therefore, it is preferable that the presser springs 631, 832, and 633 are inclined by 1 degree or more with respect to the surface of the sample plate 5. On the other hand, when the presser springs 631, 832, and 633 are excessively inclined, the force of pressing the sample plate 5 from the lower side toward the projecting portions 912 to 914, which is an original function, becomes weak. In consideration of this point, it is preferable that the inclination angles of the presser springs 631, 832, and 633 are 60 degrees or less.

In the sample plate holder 9, the lengths (projecting lengths) of the projecting portions 912 to 914 are made smaller than those of the sample plate holder 6 of the first embodiment. Specifically, in the sample plate holder 6, the lengths of the projecting portions 612 and 613 are 3.3 mm, and the length of the projecting portion 614 is 2.8 mm, whereas in the sample plate holder 9, the lengths of the projecting portions 912 and 913 are 1.5 mm, and the length of the projecting portion 914 is 1.0 mm. Here, the length of a projecting portion refers to the length of a portion overlapping the sample plate 5 in plan view in the entire length of the projecting portion. As can be seen from FIG. 8, depending on surface accuracies of the projecting portions 912 to 914, the positions of the support points in the sample plate 5 change by the lengths of the projecting portions 912 to 914 at their maximum. In the sample plate holder 9, since the projecting portions 912 to 914 are shortened, even if the contact surfaces of the projecting portions 912 to 914 are inclined due to a machining error at the time of manufacturing, a positional deviation of the support points is suppressed to be small, whereby the positional deviation between the force points and the support points in plan view is suppressed to be small. Therefore, the distortion of the sample plate 5 can be further reduced as compared with the sample plate holder 6. As described above, in the sample plate holder 6, the lengths of the projecting portions 612 and 613 are 3.3 mm, but according to the study of the present inventor, by setting the lengths of the projecting portions 912 to 914 to 3.0 mm or less, distortion of the sample plate 5 can be suppressed even if the projecting portions 912 to 914 are inclined.

The projecting portions 912 to 914 may be inclined surfaces. Specifically, the projecting portions 912 to 914 are inclined in a direction away from the surface of the sample plate 5 from the outside toward the inside. As a result, as schematically illustrated in FIG. 11, not only the presser springs 832 and 633 but also the projecting portions 912 to 914 abut on the ridgeline of the sample plate 5 (edge portion on the short side of the surface of the sample plate 5; corner portion in the C-C′ cross section). By adopting such a configuration, the positions of the force points and the support points in the sample plate 5 more precisely coincide with each other in plan view, and the occurrence of distortion in the sample plate 5 can be more reliably suppressed.

Alternatively, the projecting portions 912 to 914 may not be provided, and the projecting piece 911 may be inclined in a direction away from the surface of the sample plate from the outside toward the inside to bring the ridgeline of the sample plate 5 and the projecting piece 911 into linear contact with each other. However, in this case, the projecting piece 911 is required to be a flat inclined surface as a whole (inclination angle is uniform). Therefore, as described above, it is preferable to adopt a configuration in which the projecting portions 912 to 914 provided on the projecting piece 911 are inclined surfaces.

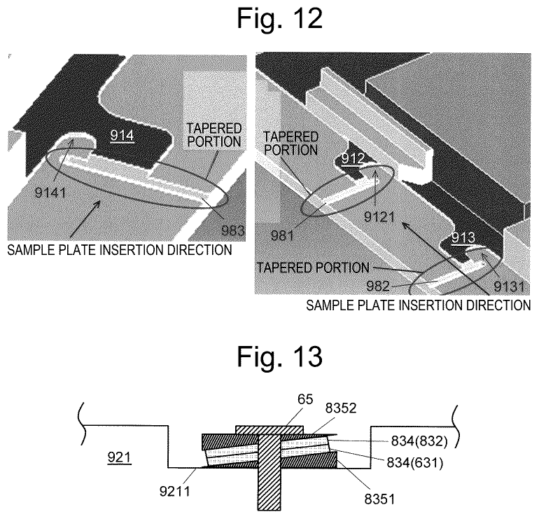

In the sample plate holder 9, as illustrated in FIG. 12, depressions 9121, 9131, and 9141 are provided on base portion sides of the projecting portions 912, 913, and 914. V-shaped grooves 981 to 983 are formed in portions of the projecting portions 912 to 914 located on a side where the sample plate 5 is inserted, whereby end portions of the projecting portions 912 to 914 on the side where the sample plate 5 is inserted are tapered. In the sample plate holder 6 of the first embodiment, the projecting piece 611 is provided with flat projecting portions 612 to 614. The projecting portions 612 to 614 are not completely rectangular and have a shape expanding toward their base portion sides (FIG. 3). Therefore, a step is generated at a boundary between the projecting piece 611 and the projecting portions 612 to 614, and when the sample plate 5 is inserted, the sample plate 5 is caught by the step, and work may take time.

On the other hand, in the sample plate holder 9 of the third embodiment, the boundary between the projecting piece 911 and the projecting portions 912 to 914 is tapered, and the sample plate 5 can be smoothly inserted since there is no expansion at the base portions of the projecting portions 912 to 914. In FIG. 12, the V-shaped grooves 981 to 983 are formed, but the tapered portion may be provided by another method. However, since the thicknesses of the projecting portions 912 to 914 are 0.1 mm, which is very thin, similarly to the sample plate holder 6, it is not easy to perform machining of forming inclined surfaces on the projecting portions. As illustrated in FIG. 12, the tapered portion can be easily provided by forming the V-shaped grooves in the end portions of the projecting portions 912 to 914.

The above-described embodiments are merely examples, and can be appropriately modified in accordance with the spirit of the present invention.

Although the mass spectrometer 1 including vacuum MALDI has been described above, the sample plate holders 6 to 9 of the above-described embodiments and modifications can also be suitably used in a mass spectrometer including atmospheric pressure MALDI or another ion source that irradiates a sample with laser light when ionizing the sample. For example, the sample plate holders 6 to 9 of the above embodiments and modifications can also be suitably used in a mass spectrometer including an ion source that generates ions from a sample by the laser desorption/ionization method (LDI) or the electrospray laser desorption ionization method (ELDI), or in a mass spectrometer of laser ablation inductively coupled plasma mass spectrometry (LA-ICP MS).

In the above embodiments, the mass spectrometer 1 having a reflectron TOF type mass spectrometry unit is used, but the sample plate holder 6 of the above embodiments and modifications can be suitably used regardless of a configuration of a mass separation unit, such as a linear TOF type, an ion trap type, and a quadrupole type.

In the sample plate holders 6 to 9 of the above embodiments and modifications, the projecting portions 612 to 614 and 912 to 914 and the presser springs 631, 632, 633, and 832 used as the contact members and the biasing members are merely configuration examples, and can be replaced with appropriate members that function as the contact members and the biasing members in the present invention. For example, as the biasing members, a spring or an extrusion pin that biases the sample plate 5 to the upper frame members 61 and 71 from below the contact portions can also be used.

In the sample plate holder 9, the presser springs 631, 832, and 633 are inclined by inclining the mounting surface 9211 of the screw 65 with respect to the surface of the sample plate 5, but other methods can be adopted. For example, as schematically illustrated in FIG. 13 (a modification of the third embodiment), the mounting surface 9211 of the screw 65 is parallel to the surface of the sample plate 5, and a washer 8351 having an inclined surface inclined with respect to the surface of the sample plate 5, the fixation section 834, and a washer 8352 having an inclined surface inclined to the opposite side to the washer 8351 are sandwiched between the mounting surface 9211 and the screw 65 and fixed with the screw 65, whereby the presser springs 631, 832, and 633 can be inclined with respect to the surface of the sample plate 5.

### Modes

A person skilled in the art can understand that the previously described illustrative embodiments are specific examples of the following modes of the present invention.

### Clause 1

A sample plate holder for a mass spectrometer according to a mode of the present invention includes:
a biasing member configured to press one surface of a sample plate at three positions not located on a straight line; and
a contact member which abuts on another surface of the sample plate at positions corresponding to the three positions in plan view.

In the sample plate holder according to clause 1, the biasing member presses one surface (for example, the lower surface) of the sample plate at three positions (three points) not positioned on a straight line, and the biasing member is brought into contact with the contact member at positions corresponding to the three positions (typically, three positions at the same positions) in plan view. In the sample plate holder according to clause 1, since the force points for pressing the sample plate and supporting points of the sample plate are at the same position in plan view, the sample plate is not distorted. Since a flat plane is defined by three points that are not positioned on a straight line, the sample plate can be held such that the surface of the sample plate is always held at the same position and height by using the sample plate holder according to clause 1.

### Clause 2

A sample plate holder according to clause 2 is the sample plate holder according to clause 1, wherein the contact member is integrally made of a reinforcing member having an area larger than an area of the contact member in plan view.

### Clause 3

A sample plate holder according to clause 3 is the sample plate holder according to clause 2, wherein
the sample plate is substantially rectangular, and
the reinforcing member is formed along each of both short sides of the sample plate on one surface of the sample plate.

In the sample plate holder according to clause 2, in a case where a predetermined voltage is applied to the sample plate and the sample plate holder, even in a case where a step between an upper surface of the sample plate and an upper surface of the sample plate holder is reduced to suppress disturbance of an electric field, sufficient intensity can be secured by the reinforcing member. The sample plate holder according to clause 3 can be suitably used when holding a widely used rectangular sample plate.

### Clause 4

A sample plate holder according to clause 4 is the sample plate holder according to any one of clauses 1 to 3, wherein
at least one of the three positions is located in each of two regions divided by a plane passing through the center of gravity of the sample plate and perpendicular to the surface of the sample plate.

By using the sample plate holder according to clause 4, the sample plate can be stably held as compared with a case where the sample plate is held in only one of the two regions.

### Clause 5

A sample plate holder according to clause 5 is the sample plate holder according to any one of clauses 1 to 4, wherein the biasing member abuts on an edge portion of the sample plate.

### Clause 6

A sample plate holder according to clause 6 is the sample plate holder according to clause 5, wherein
the biasing member is three leaf springs, and each of the three leaf springs is disposed to be inclined with respect to the surface of the sample plate so as to be away from the surface of the sample plate from the outside to the inside of the sample plate.

### Clause 7

A sample plate holder according to clause 7 is the sample plate holder according to clause 6, wherein
a first leaf spring which is one of the three leaf springs is disposed along one side of the sample plate, and
a second leaf spring and a third leaf spring, which are two of the three leaf springs, are disposed along a side facing the one side.

### Clause 8

A sample plate holder according to clause 8 is the sample plate holder according to clause 7, wherein
the third leaf spring is disposed inside the sample plate with respect to the second leaf spring, and includes a linear portion and an extension portion extending from the linear portion to the outside of the sample plate.

In the sample plate holder according to clause 5, the biasing member presses the edge portion of the sample plate, so that a positional deviation of the force points in the sample plate is reduced. As such a configuration, for example, three leaf springs as described in clause 6 can be suitably used. In addition, by disposing the three leaf springs described in clause 6 as described in clause 7, it is possible to hold the sample plate so as to press the sample plate from the outside of the two opposing sides of the sample plate. Among the three leaf springs, the third leaf spring disposed on the inner side of the other leaf springs is configured as described in clause 8, so that not only the first leaf spring and the second leaf spring but also the third leaf spring can be configured to press the edge portion of the sample plate.

### Clause 9

A sample plate holder according to clause 9 is the sample plate holder according to any one of clauses 6 to 8, further including:
a first frame member provided with the contact member; and
a second frame member to which the three leaf springs are attached, the second frame member being a member fixed to the first frame member,
wherein the sample plate is held between the first frame member and the second frame member.

### Clause 10

A sample plate holder according to clause 10 is the sample plate holder according to clause 9, wherein
the second frame member is provided with a mounting surface inclined with respect to the surface of the sample plate, and the three leaf springs are attached to the mounting surface.

### Clause 11

A sample plate holder according to clause 11 is the sample plate holder according to clause 9, wherein
the second frame member is provided with a mounting surface parallel to the surface of the sample plate, and the leaf springs are attached to the mounting surface via inclined members having inclined surfaces inclined with respect to the surface.

As described in clause 9, one mode of the sample plate holder according to the present invention includes the first frame member provided with the contact member and the second frame member to which the three leaf springs are attached, and the sample plate can be held between the first frame member and the second frame member. Then, the three leaf springs can be attached in an inclined manner with respect to the surface of the sample plate by providing the mounting surface inclined with respect to the surface of the sample plate on the second frame member as described in clause 10, or by disposing the inclined members having inclined surfaces inclined with respect to the surface of the sample plate as described in clause 11.

### Clause 12

A sample plate holder according to clause 12 is the sample plate holder according to any one of clauses 9 to 11, wherein
a portion of the contact member located on a side where the sample plate is inserted is formed in a tapered shape.
In the sample plate holder according to clause 12, the sample plate can be smoothly inserted.

### Clause 13

A sample plate holder according to clause 13 is the sample plate holder according to clause 12, wherein
the contact member is provided on a surface of a flat plate-shaped reinforcing member at least a part of which is located on the side where the sample plate is inserted with respect to the contact member, and is formed in the tapered shape by forming a V-shaped groove in an end portion on the side where the sample plate is inserted.

The thickness of the contact member is, for example, about 0.1 mm, and it is not easy to form the end portion of the member having such a thickness in a tapered shape. In the sample plate holder according to clause 13, the contact member is provided on the surface of the flat plate-shaped reinforcing member, and the V-shaped groove is formed at the end portion on the side where the sample plate is inserted, which is the boundary, whereby the end portion of the contact member can be formed in the tapered shape.

### Clause 14

A sample plate holder according to clause 14 is the sample plate holder according to clause 12 or clause 13, further including a side member positioned outside the short side of the sample plate; wherein
the contact member extends from the side member toward the inside of the sample plate, and a depression is formed in a base portion on the side into which the sample plate is inserted.

In the sample plate holder according to clause 14, the contact member extends from the side member provided outside the short side of the sample plate toward the inside of the sample plate. For example, in the case of forming a contact member having a rectangular shape in plan view, it is difficult to form the end portion on the side where the sample plate is inserted into a completely linear shape, and the shape is often a shape in which a hem of the end portion widens toward the base portion side. Then, when the sample plate is inserted, the sample plate is caught by a step of the hem portion. In the sample plate holder according to clause 14, since the depression is provided in the base portion of the contact member on the side where the sample plate is inserted, no catching occurs when the sample plate is inserted.

### Clause 15

A mass spectrometer according to clause 15 includes:
the sample plate holder according to any one of clauses 1 to 14;
a laser light irradiation unit configured to irradiate with laser light a sample placed on a sample plate held by a sample plate holder; and
a mass spectrometry unit configured to perform mass spectrometry of ions generated from the sample by irradiation with the laser light.

The sample plate holder described in any one of clauses 1 to 14 can be suitably used in the mass spectrometer according to clause 15, in particular, having a configuration of generating ions from the sample by irradiation with the laser light.

### Clause 16

A mass spectrometer according to clause 16 is the mass spectrometer according to clause 15, further including:
a stage on which the sample plate holder is set;
a stage moving mechanism configured to move the stage such that each of a plurality of measurement points distributed on the sample held on the sample plate is irradiated with the laser light; and
an image data creation unit configured to create image data indicating a distribution of a target substance on a surface of the sample based on mass spectrometry data obtained at the plurality of measurement points.

The sample plate holder described in any one of clauses 1 to 14 can be particularly suitably used in the mass spectrometer according to clause 16 that performs so-called imaging mass spectrometry in which mass spectrometry is performed at each of the plurality of measurement points on the sample and image data indicating the distribution of the target substance on the surface of the sample is created based on mass spectrometry data obtained at each of the measurement points.

### Clause 17

A mass spectrometer according to clause 17 is the mass spectrometer according to clause 15 or clause 16, wherein
the laser light irradiation unit generates ions from the sample via a matrix substance applied to or mixed with the sample.

The sample plate holder according to clauses 1 to 14 can be suitably used in the mass spectrometer according to clause 15, in particular, having an ion source for ionizing the sample by a matrix-assisted laser desorption/ionization method.

### REFERENCE SIGNS LIST

1 . . . Mass Spectrometer (MALDI-TOF MS)
10 . . . Chamber
12 . . . Stage
13 . . . Laser Light Irradiation Unit
14 . . . Concave Reflecting Mirror
17 . . . Image Acquiring Unit
18 . . . Stage Drive Unit
19 . . . Gate Valve
21 . . . Acceleration Electrode
22 . . . Ion Lens
30 . . . Mass Spectrometry Unit
31 . . . Flight Tube
32 . . . Reflectron
33 . . . Back Plate
34 . . . Ion Detector
40 . . . Control/Processing Unit
41 . . . Storage Unit
42 . . . Measurement Control Unit
43 . . . Analysis Processing Unit
44 . . . Input Unit
45 . . . Display Unit
5 . . . Sample Plate
6, 7, 8, 9 . . . Sample Plate Holder
61, 71 . . . Upper Frame Member
611 . . . Projecting Piece (Reinforcing Member)
612 to 614, 912 to 914 . . . Projecting Portion (Contact Member)
62 . . . Lower Frame Member
621 . . . Grip Portion
631 to 633, 832 . . . Presser Spring (Biasing Member)
64, 65 . . . Screw
8321 . . . Linear Portion
8322 . . . Extension Portion
834 . . . Fixation Section
8341 . . . Opening
8351, 8352 . . . Washer
86, 96 . . . Wall Portion (Side Member)
87, 97 . . . Leaf Spring
9121, 9131, 9141 . . . Depression
9211 . . . Screw Mounting Surface
981 to 983 . . . V-shaped Groove
C . . . Ion Optical Axis
S . . . Sample

1. A sample plate holder for a mass spectrometer, the sample plate holder comprising:
a biasing member configured to press one surface of a sample plate; and
a contact member which abuts on another surface of the sample plate only at three positions not located on a straight line in plan view.

2. The sample plate holder for a mass spectrometer according to claim 1, wherein the contact member is integrally made of a reinforcing member having an area larger than an area of the contact member in plan view.

3. The sample plate holder for a mass spectrometer according to claim 2, wherein
the sample plate is substantially rectangular, and
the reinforcing member is provided along each of both short sides of the sample plate on one surface of the sample plate.

4. The sample plate holder for a mass spectrometer according to claim 1, wherein at least one of the three points is located in each of two regions divided by a plane passing through a center of gravity of the sample plate and perpendicular to a surface of the sample plate.

5. The sample plate holder for a mass spectrometer according to claim 1, wherein the biasing member abuts on an edge portion of the sample plate.

6. The sample plate holder for a mass spectrometer according to claim 1, wherein the biasing member is three leaf springs, and each of the three leaf springs is disposed to be inclined with respect to the surface of the sample plate so as to be away from the surface of the sample plate from an outside to an inside of the sample plate.

7. The sample plate holder for a mass spectrometer according to claim 6, wherein
a first leaf spring which is one of the three leaf springs is disposed along one side of the sample plate, and
two of the three leaf springs, a second leaf spring and a third leaf spring, are disposed along a side opposite the one side.

8. The sample plate holder for a mass spectrometer according to claim 7, wherein the third leaf spring is disposed inside the sample plate with respect to the second leaf spring, and has a linear portion and an extension portion extending from the linear portion to the outside of the sample plate.

9. The sample plate holder for a mass spectrometer according to claim 6, further comprising:
a first frame member provided with the contact member; and
a second frame member to which the three leaf springs are attached, the second frame member being a member fixed to the first frame member,
wherein the sample plate is held between the first frame member and the second frame member.

10. The sample plate holder for a mass spectrometer according to claim 9, wherein the second frame member is provided with a mounting surface inclined with respect to the surface of the sample plate, and the three leaf springs are attached to the mounting surface.

11. The sample plate holder for a mass spectrometer according to claim 9, wherein the second frame member is provided with a mounting surface parallel to the surface of the sample plate, and the leaf springs are attached to the mounting surface via inclined members having inclined surfaces inclined with respect to the surface of the sample plate.

12. The sample plate holder for a mass spectrometer according to claim 9, wherein a portion of the contact member located on a side where the sample plate is inserted is formed in a tapered shape.

13. The sample plate holder for a mass spectrometer according to claim 12, wherein the contact member is provided on a surface of a flat plate-shaped reinforcing member at least a part of which is located on the side where the sample plate is inserted with respect to the contact member, and is formed in the tapered shape by forming a V-shaped groove in an end portion on the side where the sample plate is inserted.

14. The sample plate holder for a mass spectrometer according to claim 12, further comprising a side member positioned outside a short side of the sample plate,
wherein the contact member is a member extending from the side member toward the inside of the sample plate, and having a depression formed in a base portion on the side into which the sample plate is inserted.

15. A mass spectrometer comprising:
the sample plate holder for a mass spectrometer according to claim 1;
a laser light irradiation unit configured to irradiate with laser light a sample placed on a sample plate held by a sample plate holder; and
a mass spectrometry unit configured to perform mass spectrometry of ions generated from the sample by irradiation with the laser light.

16. The mass spectrometer according to claim 15, further comprising:
a stage on which the sample plate holder is set;
a stage moving mechanism configured to move the stage such that each of a plurality of measurement points distributed on the sample held on the sample plate is irradiated with the laser light; and
an image data creation unit configured to create image data indicating a distribution of a target substance on a surface of the sample based on mass spectrometry data obtained at the plurality of measurement points.

17. The mass spectrometer according to claim 15, wherein the laser light irradiation unit generates ions from the sample via a matrix substance applied to or mixed with the sample.
